(19) United States
(12) Patent Application Publication
(10) Pub. No.: US 2006/0155540 A1
(43) Pub. Date: Jul. 13, 2006

(54) Method for data training

(76) Inventors: Peilin Chou, Taipei (TW); Wai-Ping Lam, Taipei (TW); Hao-Ran Hsu, Taipei (TW); Sean Liu, Taipei (TW)

Correspondence Address: LADAS & PARRY LLP, 224 SOUTH MICHIGAN AVENUE, SUITE 1600, CHICAGO, IL, 60604, US

(21) Appl. No.: 11/325,729

(22) Filed: Jan. 5, 2006

Related U.S. Application Data
(60) Provisional application No. 60/641,832, filed on Jan. 7, 2005.

(51) Int. Cl. G10L 15/14

(52) U.S. Cl. 704/256

(57) ABSTRACT

In a method for data training, training is performed using multiple entries of data in a database of web pages, libraries, patent documents, etc., in combination with data selected or labeled by a user. The data training utilizes a scheme based principally on a machine learning algorithm but providing more efficient processing techniques. Thus, quick learning can be achieved with fewer feedbacks to save the user's time and to save computer computational resources, and data can be classified or filtered effectively.

### CROSS-REFERENCE TO RELATED APPLICATION

This application claims priority of U.S. Provisional Application No. 60/641,832, filed on Jan. 7, 2005.

### BACKGROUND OF THE INVENTION

1. Field of the Invention

The invention relates to a method for processing data, more particularly to a method for data training that can enhance learning effects.

2. Description of the Related Art

With improvements in computing efficiency and speed, data processing techniques of artificial intelligence, such as Neural Network, Naïve Bayes, SVM, etc., which were not widely applied in the past for consuming huge computer resources required for computations, have begun to flourish in the past decade. The data processing process can be said to be carried out through a system. The system can, in response to an input, generate an output matching or approximating a standard. The system's functionality includes, at least, digital data recognition, classification, filtering, and path prediction, and the system can have different applications, such as industrial control equipment, various databases, biological data, meteorological prediction, commercial investment analyses, management, etc. The aforesaid standard may be a known standard, a system predetermined result, user preferences or expectations, etc.

In order that the system can operate accurately, the system has to repeatedly learn through data training until it is possible to have each input correspond accurately to the required output. The untrained data must have a test object, i.e., test data, which can be a feedback from the user or trained data. When the test data are not accurate or too few, the accuracy of the results outputted by the system will be significantly affected.

Take the classification function as a concrete example. The system is equivalent to a classifier which can determine and classify the data in a database when trained over and over again.

At the beginning of the training when the test data are sparse, the system is unstable, and the classification results outputted thereby are not reliable. Besides, for newly added untrained data, the classification results are also cluttered. With an increase in the amount of test data and the number of trainings, the system is gradually adjusted so that the classification results outputted thereby get closer and closer to the standard. Assuming that the amount of the test data is sufficient, every time a new document is added, the system will start training anew using the new document and the trained old documents. The objective of training is to adjust the system so that it can perform accurate classification whenever a new document is added.

With the number of trainings as the x-axis and the standard matching rate as the y-axis, a learning curve can be defined. When the learning curve converges, i.e., 100% compliance with the standard, and stops changing, the training can be said to have been completed. If the learning curve can be made to converge quickly, this indicates that the system learns fast, and that the user does not need to make many feedbacks or perform much training to achieve the expected classification effects.

However, judging from the current data processing techniques, every time a new document is added, all the trained old documents have to be retrained together therewith, which not only entails considerable amounts of computation and consumes computer resources, the user also needs to wait for a relatively long time for the training results. Most importantly, the learning curve grows slowly. Although improvement of the computing efficiency of the computer hardware itself can be anticipated, there is still a need for improving and enhancing the data processing techniques.

### SUMMARY OF THE INVENTION

Therefore, an object of the present invention is to provide a method for data training in which a learning curve can be made to converge quickly during the process of addition of or combination with a new document.

Another object of the present invention is to provide a method for data training capable of automatic fine-tuning to eliminate obvious errors.

Accordingly, the method for data training of the present invention is implemented through a data storage medium to train with a plurality of data in a database of web pages, libraries, patent documents, etc., in combination with feedback operations of the user, such as the user's selection or labeling of data. The method of training is, in principle, based on conventional machine learning algorithms, but provides more efficient processing techniques so that fast learning can be achieved with relatively fewer feedbacks, thereby saving the user's time and computer computing resources and thereby achieving effective classification or filtering of the data.

Each entry of data in the database is represented by a multi-dimensional vector, i.e., each datum is composed of parameters describing the attributes of the datum and the corresponding weight parameters. The data may include trained or untrained data, and may be considered as points in a multi-dimensional space. The entire corpus of labeled or trained data is regarded as an old model, and is defined as H(t), where t represents the number of trainings. That is, the old model may vary with the number of trainings. Untrained and subsequently added or combined data, such as feedback data newly selected and given a positive or negative label by the user, belong to the new document. A system that implements the method of this invention is equivalent to a classifier, and can be considered as a hyper plane that separates the data in the multi-dimensional space for classifying the data in the old model.

At the start when the amount of data in the old model H(t) is sparse, the definition of the hyper plane is not very clear, and classification results of unknown inputted data are also unreliable. With an increase in the number of feedbacks from the user and the number of trainings, the hyper plane will be adjusted gradually so that the classification results outputted by the classifier get closer and closer to the standard.

In the case that a new document is added to the old model H(t), an efficient way of training with the data needs to be used to adjust the hyper plane. The method for data training according to the present invention includes the following steps:

1. Providing an old model H(t):

The old model H(t) refers to a classifier that is generated after receiving and learning feedback data selected or labeled by the user for t times, and that represents a classifier of a transitional period.

2. Selecting retrain data, with the rest serving as test data:

The method of the present invention is not employed to retrain the entire old model. Only a part of the old model is selected for training. At the start of the training, the retrain data can be extracted at random or in full from the old model. However, after several trainings, the data can be classified as extremely stable data, i.e., indexing data that can be easily classified, and data whose classification results are unstable. These two extreme data are selected as retrain data. The test data are data that are not selected.

3. Receiving a new document:

The new document refers to data fed back by the user and used to serve as reference for the t+1th training.

4. Generating new training data and new test data:

The new training data are the retrain data plus the new document, whereas the new test data are the test data plus the new document.

5. Training with the new training data to obtain a new training model h(t+1):

The method of the present invention is adapted to train with new training data of a relatively sparse amount using a scheme, such as Neural Network, Naïve Bayes, SVM, etc., to obtain the new training model h(t+1) so as to replace the conventional method of training with the entire old model plus the new document. The new training model h(t+1) may have an influence on the old model H(t) to thereby adjust the same into a new classifier.

6. Converting multi-dimensions to two-dimensions:

Another crucial feature of the method of the present invention resides in this dimension converting step, which can enhance learning accuracy and reduce computation amounts. All the data in the old model H(t) can be regarded as being scattered over a multi-dimensional space, and the entire corpus of data is a multi-dimensional vector. The correlation between the old model H(t) and each new test datum is calculated to obtain a pure amount v₁. The correlation between the new training model h(t+1) and each new test datum is calculated to obtain a pure amount v₂. Since the new training model h(t+1) generally represents latest preferences of the user, it should have more potent influence. Therefore, v₂ is multiplied by an amplifying factor α greater than 1, and the correlation of the new test data with H(t) and h(t+1) are expressed as a two-dimensional model [v₁, αv₂].

7. Retrain with [v₁, αv₂] to form a two-dimensional weighting model [p, q]:

Since the α in step 6 is a given value, [v₁, αv₂] herein is retrained to obtain an optimized two-dimensional weighting model [p, q] so as to serve as learning data.

8. Generating a new model H(t+1) in combination with the weighting model:

As shown in the following equation, the new model H(t+1) is obtained by adding the old model H(t) and the new training model h(t+1) weighted respectively by p and q.
p*H(t)+q*h(t+1)→H(t+1) equation 1
9. Automatically fine-tuning H(t+1):

While the user is not waiting, the system can fine-tune itself so as to eliminate obvious learning errors. The fine-tuning includes the following steps: (1) classifying or filtering all the data in the database with reference to the newly generated new model H (t+1), and arranging the data according to the degrees of correlation between the data and the new model H(t+1); (2) selecting the first N entries of data with highest degrees of correlation; (3) obtaining a mean value of the N entries of data, i.e., a vector centroid; (4) calculating a degree of matching between the vector centroid and the new model H(t+1); a degree of correlation therebetween may be calculated in actual practice; and (5) if the degree of matching is not within a predetermined range, this indicates that the new model H(t+1) is unable to properly classify or filter unknown data and should be adjusted. Therefore, the centroid is regarded as a new document with a negative label to serve as a reference basis for the next training, and steps 2-8 are repeated.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic diagram illustrating how data in a database are classified using the preferred embodiment of a method for data training according to the present invention; and

FIG. 2 is a flowchart of the preferred embodiment.

### DETAILED DESCRIPTION OF THE PREFERRED EMBODIMENT

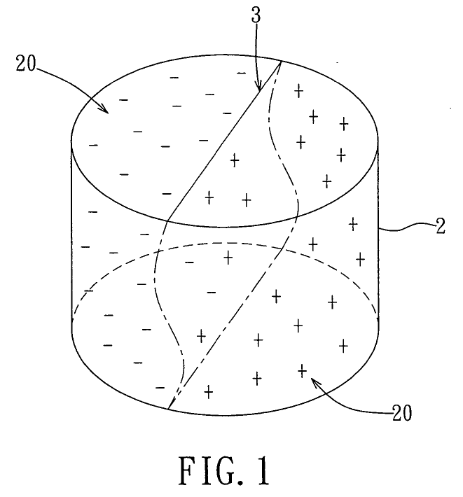

Referring to FIG. 1, the preferred embodiment of a method for data training of this invention is adapted to be applied to a smart agent exclusively provided to each user, i.e., a system for executing the method. The smart agent is trained with a plurality of entries of data 20 in a web page database 2 in cooperation with feedback operations of the user. In this embodiment, the feedback operation of the user refers to the user's selection of an article on a web page, a paragraph, or marking of an entire web page, and then giving a positive comment (meaning the user is interested) or a negative comment (meaning the user is not interested) for subsequent addition to the database 2. The scheme of training, in principle, is based on a conventional machine learning algorithm, but provides more efficient training techniques, including automatically classifying and filtering the data 20 that are subsequently added to the database 2, thereby accurately providing the user with suitable material. Specifically, a determination is made as regards the contents of the web page that are not browsed by the user, and a positive or negative comment thereon is predicted to further provide “automatic supply” or “automatic filtering” services.

Once the smart agent has received the data 20 fed back by the user, the method for data training according to the present invention can be conducted. In the method, each entry of data in the database is represented by multi-dimensional vectors, as follows:
D₁=(T₁W₁₁) [symbol] (T₂W₁₂) [symbol] (T₃W₁₃) . . . (TₙW₁ₙ)
D₂=(T₁W₂₁) [symbol] (T₂W₂₂) [symbol] (T₃W₂₃) . . . (TₙW₂ₙ₎
where T₁, T₂, T₃ . . . are parameters describing attributes of the data, and W is the corresponding weighting parameter. Therefore, the smart agent may be considered as a classifier, i.e., a hyper plane 3 for separating the data in a multi-dimensional space.

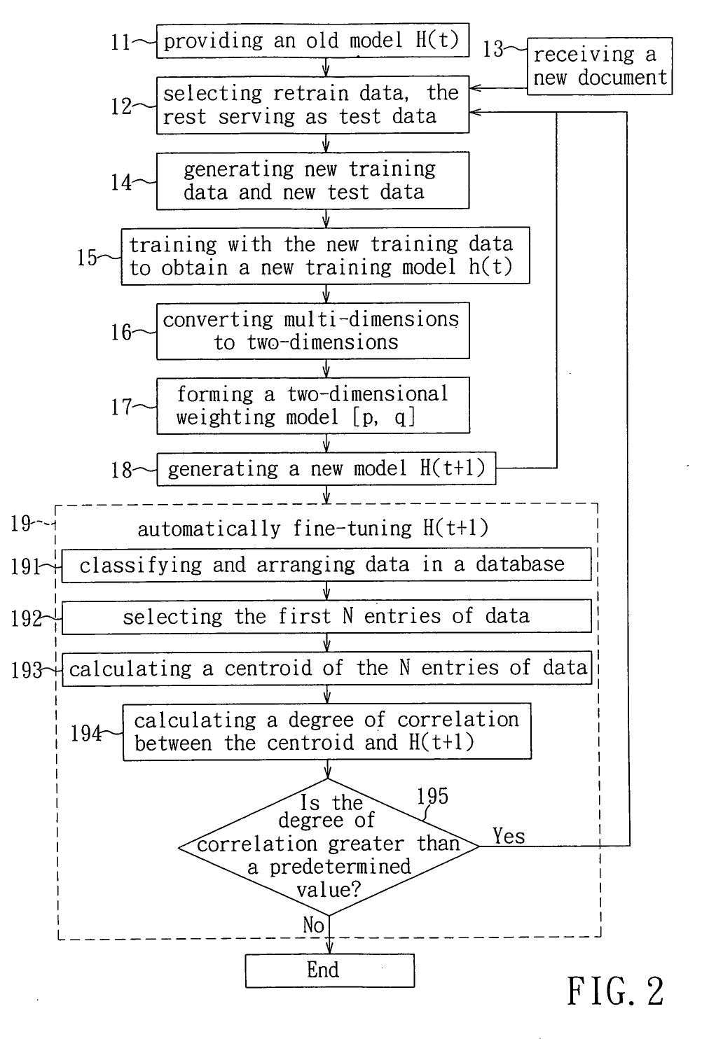

Referring to FIG. 2, in this embodiment, the method of the present invention includes the following steps:

In step 11, an old model H(t) is provided. The old model H(t) is determined from the trained data fed back by the user previously, and is defined as H(t), where t represents the number of trainings, i.e., the old model H(t) represents a hyper plane 3 at t. At the beginning when the amount of data in the old model H(t) is sparse, the definition of the hyper plane 3 is relatively not clear, and the classification results of unknown inputted data 20 are relatively unreliable. With an increase in the number of feedbacks by the user and the number of trainings, the hyper plane 3 will be adjusted gradually so that the outputted classification results get closer and closer to the standard.

In step 12, retrain data are selected, with the rest serving as test data. When the amount of data in the old model H(t) is sparse, the retrain data can be extracted at random or in full from the old model H(t). However, after several trainings, indexing data that are easier to be classified correctly (i.e., those data whose results at each classification are stable and which belong to extremely positive or extremely negative data) and data whose classification results are unstable (i.e., those data which are sometimes classified as positive data and sometimes classified as negative data) can generally be discriminated. The two aforesaid types of data are selected as retrain data. The test data are data that are not selected.

In step 13, a new document is received. The new document refers to data fed back by the user to be added or combined, for use in a (t+1)th training to serve as a reference for adjusting the hyper plane 3.

In step 14, new training data and new test data are generated. The new training data include the new document plus the retrain data, whereas the new test data include the new document plus the test data.

In step 15, training with the new training data is conducted to obtain a new training model h(t+1). In this embodiment, only the selected data, which are relatively sparse in amount, are employed during training using a scheme, such as Neural Network, Naïve Bayes, SVM, etc., to obtain the new training model h(t+1), as opposed to the training with the entire old model plus the new document in the prior art. The new training model h(t+1) may have an influence on the old model H(t) to thereby adjust the same so as to obtain a new classifier.

In step 16, multiple dimensions are converted to two-dimensions. All the data in the old model H(t) can be regarded as being scattered over a multi-dimensional space. The entire corpus of data is a multi-dimensional vector. The correlation between the old model H(t) and each new test datum is calculated to obtain a pure amount v₁. The correlation between the new training model h(t+1) and each new test datum is calculated to obtain a pure amount v₂. Since the new training model h(t+1) generally represents latest preferences of the user, it should have more potent influence. Therefore, v₂ is multiplied by an amplifying factor α greater than 1, and the correlations of the new test data with H(t) and h(t+1) are expressed as a two-dimensional model [v₁, αv₂].

In step 17, [v₁, αv₂] are retrained to form a two-dimensional weighting model [p, q]. Since the a in step 16 is a given value, [v₁, αv₂] herein is retrained to obtain an optimized two-dimensional weighting model [p, q] so as to serve as learning data.

In step 18, a new model H(t+1) is generated based on the weighting model. The new model H(t+1) is obtained by adding the old model H(t) and the new training model h(t+1) weighted respectively by p and q.
p*H(t)+q*h(t+1)→H(t+1)

Basically, after the execution of steps 11 to 18, training directed to the addition of the new document is complete, and a classifier, i.e., the hyper plane H(t+1), which can better meet the user's current expectations, is obtained with a higher efficiency. However, the system that performs the method of the preferred embodiment can additionally perform the following inspection and fine-tuning operations in order to eliminate obvious learning errors.

In step 19, the new model H(t+1) is automatically fine-tuned. The step of fine-tuning includes the following sub-steps.

In sub-step 191, the new model H(t+1) is employed to classify or filter all the data in the database to which it is applied, and the data are arranged in order of their degrees of correlation with the new model H(t+1).

In sub-step 192, the first N entries of data with the highest degrees of correlation are selected.

In sub-step 193, a vector centroid of the N entries of data is obtained.

In sub-step 194, the degree of matching between the centroid and the new model H(t+1) is calculated. In this embodiment, this sub-step is carried out by calculating a degree of correlation between the centroid and the new model H(t+1), or an angle between two vectors. However, the present invention should not be limited to this aspect.

In sub-step 195, if the degree of correlation is greater than a predetermined value, this indicates that the new model H(t+1) is unable to properly classify or filter unknown data and should be adjusted. Therefore, the centroid will be regarded as a new document with a negative label, and will serve as a reference basis for the next training. Then, steps 12-18 are repeated.

Since the above fine-tuning step is performed automatically by the system, which is equivalent to the simulation of the user's generation of feedback data, any obvious errors in previous training and learning results that may have been generated can be eliminated in this step. Therefore, the user can achieve more mature learning effects without having to make a lot of feedbacks.

In sum, the present invention is directed to training using data in the old model H(t), which have specific attributes, together with an added new document to thereby reduce computer computational burden and speed up learning effects. Thus, the learning curve can be made to converge quickly. The system that implements the method of this invention also has a self fine-tuning function.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

We claim:

1. A method for data training, which is for training with a plurality of trained data in a database in combination with an untrained new document having one of positive and negative labels, said method comprising:
(A) providing an old model representing learning results of a previous training;
(B) selecting extremely stable learning results and extremely unstable data from the trained data to serve as retrain data, with the rest of the trained data serving as test data;
(C) combining the retrain data with the new document to define a new training model, and combining the test data with the new document to define new test data;
(D) obtaining a correlation between the old model and the new test data and a correlation between the new training model and the new test data to obtain a two-dimensional model; and
(E) using the correlation between the old model and the new test data as a weight for the old model, and using the correlation between the new training model and the new test data as a weight for the new training model, and adding the weighted old model and the weighted new training model to obtain a new model representing new learning results.

2. The method for data training as claimed in claim 1, wherein, in the two-dimensional model, the correlation between the new training model and the new test data is multiplied by an amplifying factor greater than 1 to serve as the weight for the new training model.

3. The method for data training as claimed in claim 2, wherein the two-dimensional model is an optimized two-dimensional weighting model obtained by retraining.

4. The method for data training as claimed in claim 1, wherein, in step (C), the new training model is obtained by combining and training with the retrain data and the new document.

5. The method for data training as claimed in claim 1, further comprising a step (F) of automatically inspecting and fine-tuning the new model, which includes the following sub-steps:
(F-1) training with and arranging all the data in the database based on the new model;
(F-2) selecting a plurality of entries of data with highest degrees of correlation from the database;
(F-3) obtaining a mean of the plurality of entries of data selected in sub-step (F-2);
(F-4) calculating a degree of matching between the mean data and the new model; and
(F-5) if the degree of matching is not within a predetermined range, considering the mean data as a new document with the negative label, and repeating steps (A) to (E).

6. A data storage medium comprising program instructions for causing a system to execute consecutive steps of a method for data training, the method being employed for training with a plurality of trained data in a database in combination with an untrained document having one of positive and negative labels, the method comprising:
(A) providing an old model representing learning results of a previous training;
(B) selecting extremely stable learning results and extremely unstable data from the trained data to serve as retrain data, with the rest of the trained data serving as test data;
(C) combining the retrain data with the new document to define a new training model, and combining the test data with the new document to define new test data;
(D) obtaining a correlation between the old model and the new test data and a correlation between the new training model and the new test data to obtain a two-dimensional model; and
(E) using the correlation between the old model and the new test data as a weight for the old model, and using the correlation between the new training model and the new test data as a weight for the new training model, and adding the weighted old model and the weighted new training model to obtain a new model representing new learning results.
